(19) United States
(12) Patent Application Publication
(10) Pub. No.: US 2005/0289474 A1
(43) Pub. Date: Dec. 29, 2005

(54) Presentation of information based on digital identities

(75) Inventors: Adarbad Master, Oldsmar, FL (US); Nigel Simmons, Potomac, MD (US); Ayman Hariri, Potomac, MD (US)

Correspondence Address: SUGHRUE, MION, PLLC, 2100 Pennsylvania Avenue, NW, Washington, DC, 20037-3213, US

(73) Assignee: Ayman, LLC

(21) Appl. No.: 10/873,450

(22) Filed: Jun. 23, 2004

(51) Int. Cl. G06F 3/00; G06F 17/24

(52) U.S. Cl. 715/765; 715/744; 715/866; 715/747; 715/522; 715/523; 715/530

(57) ABSTRACT

Methods for controlling the display of information shared between users are disclosed. For example, an individual may agree to share his or her contact information with other users, for example, by exchanging one or more vCards of which the individual is considered the owner. The owner has a first relationship with a first user and a second relationship with a second user. Using dynamic electronic presentation skins, which are selected based on the relationships between the parties, the owner's contact information is presented to the first user in a first fashion and presented to the second user in a second fashion. If the relationship between the owner and the first and/or second user changes, a different dynamic presentation skin can be applied to the owner's contact information in the form of a vCard to alter the presentation of the information contained therein.

### BACKGROUND OF THE INVENTION

1. Field of the Invention

The invention generally relates to the presentation of information on a computerized device and, more particularly, to the presentation of information based on digital identities.

2. Description of the Related Art

A vCard is a common data structure that is used as a standard to exchange contact information, in an electronic form, between people. Such vCards are created to be presented to the recipient of the card in a specific manner, sometimes associated with a particular design for the card. However, such a presentation is static in that it remains the same throughout the life of the vCard. Also, the same design is used whenever the vCard is sent to another person, regardless of the relationship between the sender and the recipient. It would be desirable for a sender to be able to change the design of the vCard depending on the relationship between the sender and the receiver. It would also be desirable for the sender to change the appearance of the card after it has been distributed to one or more recipients. For example, the sender's business card may be designed to incorporate the sender's company logo. However, if the sender changes companies, it would be desirable for the vCards that the sender has distributed to business contacts to automatically change designs to present the logo of the sender's new employer.

Conventionally, when a “skin” is applied to an entity (e.g., an application, a graphical user interface (GUI), a window, data, etc.), the appearance of the entity changes. Likewise, the appearance of data presented in the entity may be changed in accordance with the skin. Thus, skins provide a mechanism for users to change (e.g., personalize) the appearance of entities.

For example, a skin applied to a media player application program, such as WINDOWS MEDIA PLAYER from Microsoft Corp., could change the appearance of the media player application. A skin entitled “oak” could change the appearance of the media player application to give it the appearance of being constructed of wood, i.e., oak. In this manner, the media player application, including its GUI (e.g., menus, buttons, etc.) and color scheme may be changed to give the appearance of an oak finish. Additionally, the skin may also cause the appearance of any fonts (e.g., style, size, color, etc.) used by the media player application to change.

With the necessary software, a user may be able to create their own skins. Alternatively, a user can use skins created by others. Skins created by others may, for example, be included with an application that supports the skins or be found on web sites offering skins for download over the Internet.

Skins are generally, but not necessarily, separately stored from the entities that they modify. A skin may be a program, script, plug-in, data, etc.

A problem with conventional skins is that only one skin can be selected and applied (e.g., by a user) for an entity at any given time. This problem may arise because, generally, conventional skins are used to change the appearance of data presented to the user of the entity and not to data presented to other users via other entities.

Accordingly, there is a need for multiple skins to be defined by a user for an entity, for example, based on the digital identity of a recipient of the entity.

Furthermore, there is a need for a skin defined by a first user at a first entity to change the appearance of data presented to a second user at a second entity, for example, based on the digital identities of the users.

A digital identity is a unique, persistent and immutable identifier that uniquely identifies a resource, such as a person.

An example of a digital identity is a network identifier of an identity account used in the context of a social network linking a plurality of resources (e.g., people, organizations, groups, etc.), as described in co-pending Provisional Application No. 60/487,191 entitled Social Network of Identities and Query Method Therefor, the disclosure of which is incorporated herein, in its entirety, by reference. In the social network, a user (User1) can have an identity account that resides on a computer, such as a server, that holds information about User1. This information describes certain attributes about the user to identify User1 in some respect. Furthermore, as noted above, the identity account includes a unique, persistent and immutable network identifier. In this manner, the social network can link multiple identity accounts in the network to one another, where the links represent, for example, personal relationships that have been established between people.

### SUMMARY OF THE INVENTION

A method of displaying information, including one or more data items that a first user and a second user have contractually agreed to share, includes selecting a first skin by the first user; automatically sending the first skin to the second user; applying the first skin to the information to form a presentation format of the information; and displaying the information to the second user according to the presentation format, wherein the first skin is selected by the first user based on a relationship between the first user and the second user.

Another method of displaying information includes selecting a first skin and a second skin by a first user; applying the first skin to the information to form a first presentation format of the information; applying the second skin to the information to form a second presentation format of the information; displaying the information to a second user according to the first presentation format; and displaying the information to a third user according to the second presentation format.

Still another method of displaying information includes selecting a skin based on a relationship between a first user and a second user; applying the skin to the information to form a presentation format of the information; and displaying the information to the second user according to the presentation format.

Yet another method of displaying information includes selecting a first skin based on a relationship between a first user and a second user; selecting a second skin based on a relationship between a first user and a third user; applying the first skin to the information to form a first presentation format of the information; applying the second skin to the information to form a second presentation format of the information; displaying the information to the second user according to the first presentation format; and displaying the information to the third user according to the second presentation format.

### BRIEF DESCRIPTION OF THE DRAWINGS

These and other objects, features and advantages will be become fully apparent from the following detailed description taken in conjunction with accompanying drawings, wherein like reference numerals refer to like elements.

FIG. 1 illustrates relationships between users in a social network.

FIG. 2 illustrates relationships between users in a social network, including the classification of the relationships into relationship types.

FIG. 3. illustrates a conventional vCard format.

FIG. 4 illustrates a vCard created by applying a first skin to the vCard of FIG. 3.

FIG. 5 illustrates a vCard created by applying a second skin to the vCard of FIG. 3.

FIG. 6 illustrates a vCard created by applying a third skin to the vCard of FIG. 3.

FIG. 7 illustrates a vCard created by applying a fourth skin to the vCard of FIG. 3.

FIG. 8 illustrates a vCard created by applying a skin to the vCard of FIG. 3 based on a relationship between an owner of the vCard and a different user viewing the vCard.

FIG. 9 is a flowchart for explaining the use of a first embodiment of a dynamic flash skin.

FIG. 10 is a flowchart for explaining the use of a second embodiment of a dynamic flash skin.

FIG. 11 is a flowchart for explaining the use of a third embodiment of a dynamic flash skin.

FIG. 12 is a diagram of an illustrative implementation of a vCard having a skin applied thereto.

### DETAILED DESCRIPTION OF ILLUSTRATIVE EMBODIMENTS

Hereinafter, embodiments of a dynamic flash skin will be described in with reference to the accompanying drawings.

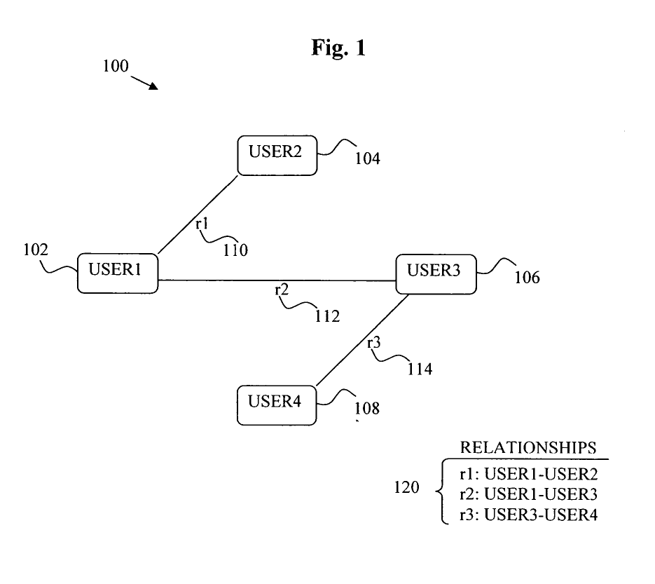

By way of introduction, an example of the aforementioned social network is illustrated in FIG. 1. In particular, the diagram of FIG. 1 illustrates relationships r1 110, r2 112 and r3 114 between users User1 102, User2 104, User3 106 and User4 108 in a social network 100. Each of the users User1 102, User2 104, User3 106 and User4 108 has an identifier (e.g., a digital identity) that uniquely identifies the particular user. For example, in the social network 100, each of the users can have an identity account that resides on a computer, such as an identity server. The identity accounts hold information about the respective users and include a unique, persistent and immutable identifier for identifying each respective user.

By associating the digital identity of a first user (e.g., User1 102) with the digital identity of a second user (e.g., User2 104), a relationship (e.g., r1 110) between the users is defined. As shown in FIG. 1, the relationships r1 110, r2 112 and r3 114 in the social network 100 can be illustrated as links between the respective users of the relationships.

Each relationship can be stored, for example, as a pair of associated users (i.e., the digital identities of the users). As shown in the relationship table 120 of FIG. 1, a relationship r1 110 is stored as an association of User1 102 and User2 104, which is represented for purposes of illustration as User 1-User2.

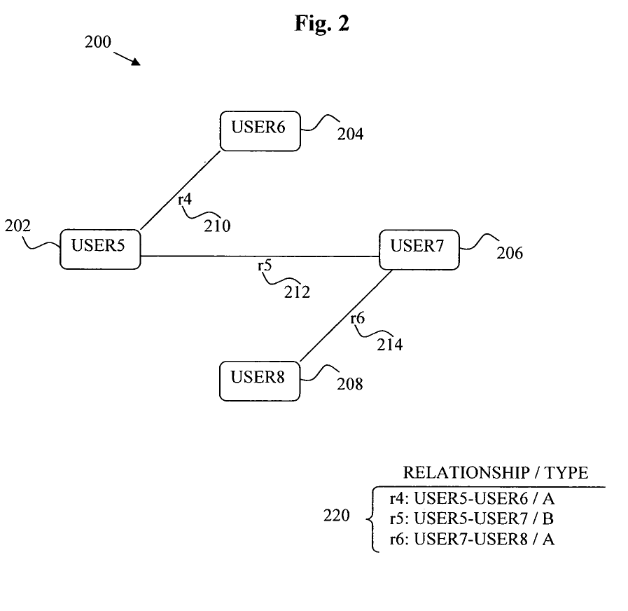

Similarly, the diagram of FIG. 2 illustrates relationships r4 210, r5 212 and r6 214 between users User5 202, User6 204, User7 206 and User8 208 in a social network 200. Beyond merely storing the relationships between the users, as illustrated in FIG. 1, a relationship table 220 of FIG. 2 also stores an assigned type of relationship. For example, in FIG. 2, the relationship r4 210 is stored as a relationship between User5 202 and User6 202 (i.e., User5-User6) and a relationship of type A.

An exemplary manner of defining the relationship type between two users is to look at the underlying nature of the relationship, which may be embodied, for example, in an electronic agreement/contract. Indeed, such relationships can be specified by using electronic contracts, or agreements, that dictate the actions one digital identity (i.e., user) may perform relative to another digital identity (i.e., user) with which it has the agreement.

Another exemplary manner of defining the relationship type between two users is to let one or both of the users define the relationship type. In the absence of a defined relationship type between two users in the social network, a default relationship type (e.g., strangers) may be applied to the exchange of information between the users.

A relationship type may be general (e.g., personal, business, etc.) or specific (e.g., softball teammates, family, etc.). In the relationship table 220 of FIG. 2, the relationships r4 210 and r6 214 have the same relationship type, i.e., type A. Conversely, relationship r5 212 has a different relationship type, i.e., type B.

Thus, as shown in FIG. 2, different relationships (e.g., r4 210 and r6 214), which may be based on different agreements/contracts between the respective users, may nonetheless be classified as being the same “type” of relationship.

While the present invention relates to dynamic flash skins that can be applied to any type of data, for purposes of illustration, non-limiting embodiments of the present invention will now be described with reference to a vCard data model.

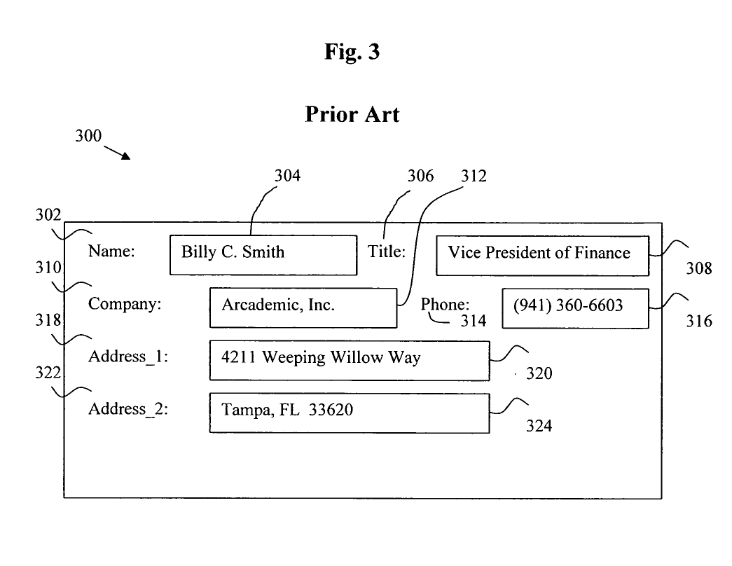

FIG. 3 illustrates a conventional vCard 300. The vCard 300 includes a format for presenting associated data. The format includes an arrangement of various data labels and data fields. The data labels include a name label 302, a title label 306, a company label 310, a phone label 314, a first address label 318 and a second address label 322. Data corresponding to each of these labels is obtained and displayed in the data fields associated with each of the data labels. The data fields include a name field 304, a title field 308, a company field 312, a phone field 316, a first address field 320 and a second address field 324. In this manner, the data is presented according to a format of the vCard 300.

For example, information describing a user, which was previously entered and/or stored, can be displayed according to the format of the vCard 300. In particular, the user's name and other contact information can be stored for later retrieval and/or viewing by the user. Additionally, the stored information can be transmitted to another user for later retrieval and/or viewing.

Thus, the vCard 300 models a real world business card. However, unlike a real world business card, a user can change/update their vCard “on the fly”, i.e., by simply changing/updating the information that is used to populate the data fields of the displayed vCard.

For example, the vCard 300 presents data for a user (hereinafter the “owner”). The owner can change/update the information for the vCard 300 at any time. Thus, if the phone number of the owner changes, the owner can edit the data representing the owner's phone number so that the updated phone number is displayed in the phone field 316 of the vCard 300. However, an exemplary problem arises because the owner of the vCard 300 cannot add or remove data that is presented in the vCard 300 and/or change the way the data itself is presented.

Another exemplary problem with the conventional vCard 300 is that the vCard 300 is displayed according to the same format for each user to whom the owner distributes the vCard 300. For example, each instance of the conventional vCard 300 is identical to every other instance of the vCard 300, such that the information of the vCard 300 is presented to each user in the same static format. Thus, each vCard 300 will have the same six data labels and six data fields, although some of the data fields may have no corresponding data (i.e., be left blank), regardless of the user viewing the vCard.

A vCard that overcomes these exemplary problems is now described.

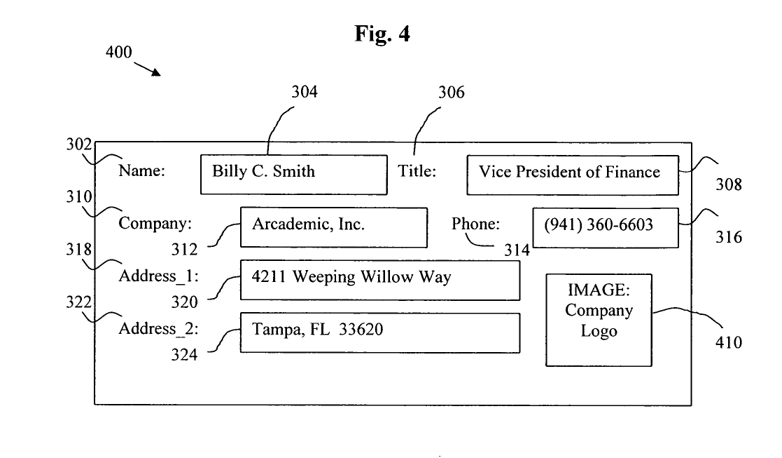

In FIG. 4, the owner of the vCard 300 selects a first skin that is then applied to the vCard 300 of FIG. 3 to create a vCard 400 which has a presentation format different from the original vCard 300. The owner's information embodied in the vCard 400 can then be displayed to one or more different users using the new presentation format corresponding to the first skin.

The vCard 400 of FIG. 4 differs from the vCard 300 of FIG. 3 in that the first skin when applied to the vCard 300 results in additional information being included in the presentation format of the original vCard 300. In FIG. 4, the vCard 400 includes an image file 410 (e.g., embedded, linked to, etc.) of the logo of the owner's employer, as the additional information. The owner of the vCard may select the first skin for use with the owner's business contacts since the skin shows the logo of the owner's employer.

The owner may select additional information (e.g., an image), i.e., in addition to the selected skin, to be associated with and displayed for the vCard. The owner may also select a second skin, to replace the first skin, after the vCard has been sent to another user. In this case, the second skin is automatically sent to the other user and the new skin applied to the information to change the presentation format of the vCard 400 to the other user.

Thus, as shown in FIG. 4, an applied skin can result in additional information being associated with and displayed for a vCard. This additional information does not necessarily have to be data relating to the content of the vCard. For example, application of the first skin to the vCard 300 of FIG. 3 might simply change the background color of the displayed vCard 400 of FIG. 4.

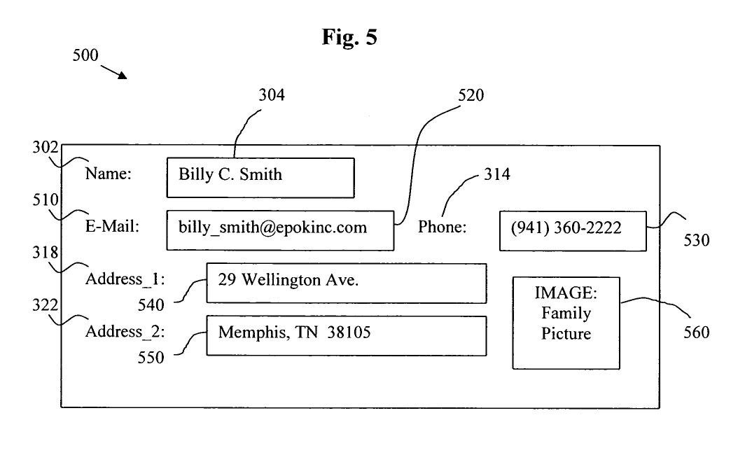

In FIG. 5, the owner of the vCard 300 selects a second skin that is appropriate for use with the owner's family members. The second skin is applied to the vCard 300 of FIG. 3 to create a vCard 500 having a presentation format different from the original vCard 300 and the vCard 400 formed by applying the first skin to the original vCard 300. The information about the owner, embodied in the vCard 500, can then be displayed to one or more different users, such as family members, in accordance with the new presentation format corresponding to the second skin.

The vCard 500 of FIG. 5 differs from the vCard 300 of FIG. 3 in that the second skin applied to the vCard 300 results in additional information being associated with and displayed for the vCard 500, information originally associated with the vCard 300 not being displayed, and different information than that originally associated with the vCard 300 being displayed for the vCard 500.

For example, in FIG. 5, additional information in the form of an image file 560 of the owner's family, an e-mail label 510 and an e-mail field 520 is displayed for the vCard 500 in accordance with the second skin. In FIG. 5, the company label 310, the company field 312, the title label 306 and the title field 308, which is data originally associated with the vCard 300, is not displayed in the vCard 500 in accordance with the second skin. Further to the additional information displayed in accordance with the second skin, other additional information (e.g., a URL to an audio clip) may be indicated by the owner.

Furthermore, the phone field 314, the first address field 318 and the second address field 322 of the vCard 300 of FIG. 3 are caused to display different data for the vCard 500 resulting from application of the second skin. Specifically, the vCard 500 contains different data in the form of a different phone number of the owner, such as the owner's home phone number, in a phone field 530 and a different address of the owner in the first address field 540 and the second address field 550, such as the owner's home address.

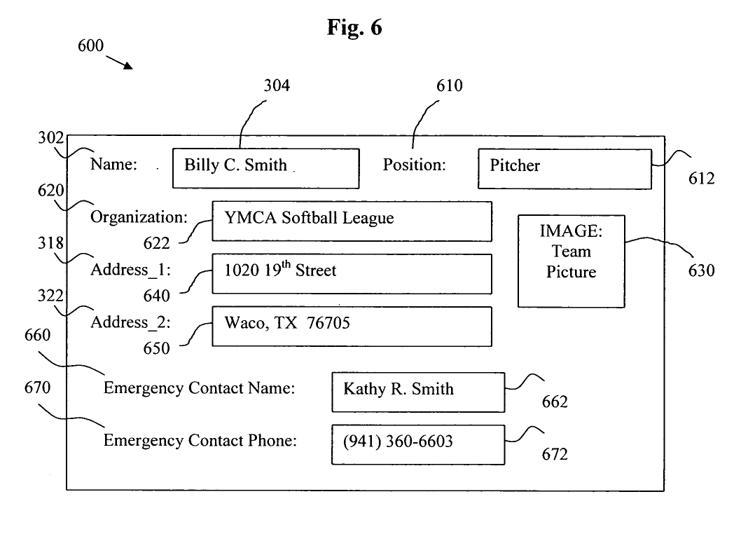

In FIG. 6, the owner of the vCard 300 selects a third skin that is appropriate for a club, such as a softball team, with which the owner is a member. The third skin is then applied to the vCard 300 of FIG. 3 to create a vCard 600 having a presentation format different from the original vCard 300, the vCard 400 formed by applying the first skin to the original vCard 300 and the vCard 500 formed by applying the second skin to the original vCard 300. The information on the owner, embodied in the vCard 600, can then be displayed to one or more different users in accordance with the new presentation format corresponding to the third skin.

New information displayed in the vCard 600 is appropriately displayed to members of the owner's softball team and includes a position label 610, a position field 612, an organization label 620, an organization field 622, an image file 630 of the owner's softball team, a first address field 640, a second address field 650, an emergency contact name label 660, an emergency contact name field 662, an emergency contact phone label 670 and an emergency contact phone field 672.

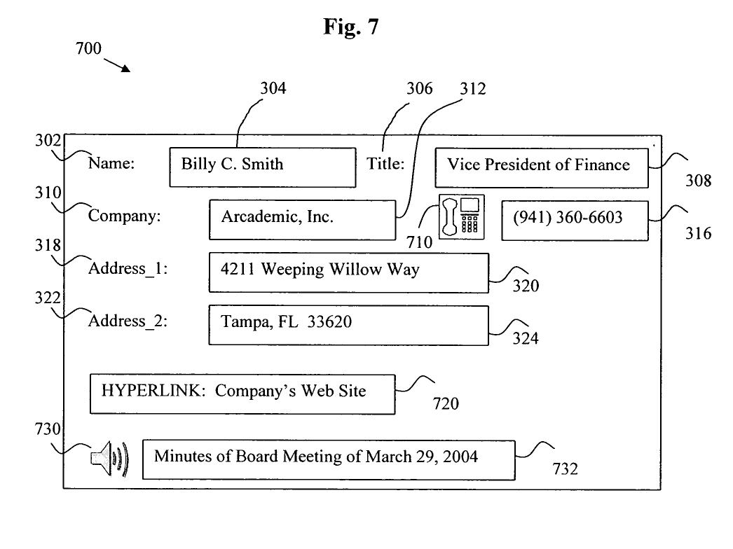

Additionally, in FIG. 7, the owner of the vCard 300 selects a fourth skin. The fourth skin is then applied to the vCard 300 of FIG. 3 to create a vCard 700 having a presentation format different from the original vCard 300, the vCard 400 formed by applying the first skin to the original vCard 300, the vCard 500 formed by applying the second skin to the original vCard 300 and the vCard 600 formed by applying the third skin to the original vCard 300. The information about the owner, embodied in the vCard 700, can then be displayed to one or more different users in accordance with the new presentation format corresponding to the fourth skin.

In FIG. 7, the vCard 700 formed by application of the fourth skin to the vCard 300 of the FIG. 3 is appropriately displayed to a subset of the business contacts for which the first skin was applied, for example, a subset of business contacts with whom the owner wants to share additional and/or specialized information.

The vCard 700 includes new information including a phone icon 710 instead of the phone label 314. Icons may offer advantages over text labels, for example, an icon may be more readily understood by a user than a text label that is in a language other than the user's native language. Additionally, given that a vCard will usually be displayed in a region having a limited size, the use of an icon may take up less display space than a lengthy text label.

Additionally, the vCard 700 includes a hyperlink 720 to the web site of the owner's employer. In FIG. 7, the minutes of a board meeting of the owner's employer, which was held on Mar. 29, 2004, are included in the vCard 700, for example, as an embedded audio file. The minutes can be accessed by interacting with (e.g., clicking with a pointing device) either of a text button 732 launcher for the audio file or an icon button 730 launcher for the audio file.

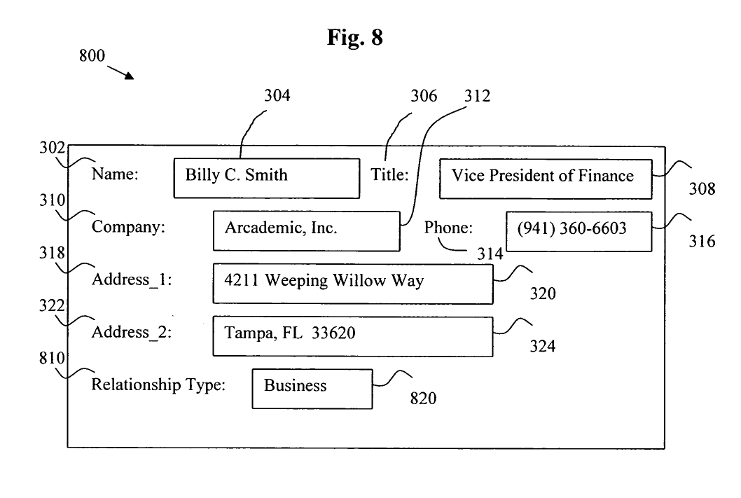

In FIG. 8, a user, for example, the owner of the vCard 300 shown in FIG. 3, creates a vCard 800 which differs from the vCard 300 in that it includes a relationship label 810 and a relationship field 820 that display a relationship between the owner of the vCard 800 and another user viewing the vCard 800 according to a particular skin applied thereto.

The owner of the vCard 800 can specify the skin to be used for formatting the display of the vCard 800 for a receiving user based on the relationship between the owner and the receiving user. In the case illustrated in FIG. 8 the relationship between the owner of the vCard and the other user is a business relationship, as specified by the user in relationship field 820.

Alternatively, the selection of the skin to apply to the vCard 800 can be performed automatically based on at least the relationship between the owner of the vCard 800 and the user receiving the vCard 800 for display.

Preferably, but not necessarily, the type of the relationship between the owner of the vCard and the receiving user is selected from a list of predetermined relationship types.

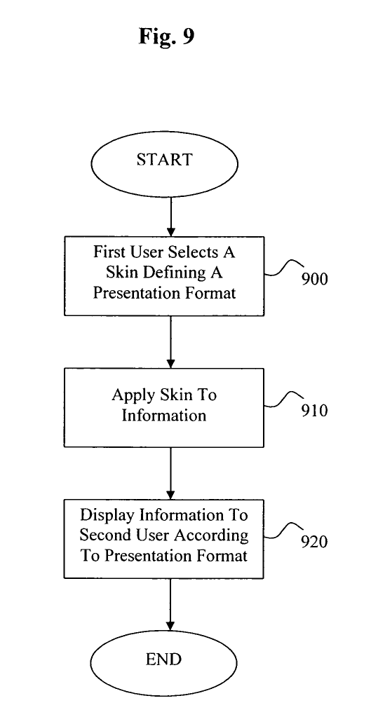

FIG. 9 is a flowchart for explaining a method of displaying information using the various types of skins discussed above. In the method, a first user selects a skin defining a presentation format for information (900). For example, the first user may select the skin from a library of pre-defined skins. Preferably, but not necessarily, the information relates to the first user.

Then, the selected skin is applied to the information to form a presentation format of the information (910). Finally, the information is displayed to a second user (e.g., at the second user's request) according to the presentation format (920). In this manner, the first user can control the manner in which the information is displayed to a second user.

The skin selected by the first user can be sent to the second user along with the information to be displayed. Alternatively, if the second user already has the skin selected by the first user (e.g., it is stored on the second user's computer), then presentation information indicating the particular skin selected by the first user is sent to the second user along with the information to be displayed.

The skins applied by a user can be dynamically and automatically changed. For example, with reference to FIG. 9, if the information shared between the first and second users is a business vCard, the vCard might contain the first user's company logo. However, if the first user goes to work for a different company, the user need not send a new vCard to the user's business contacts. Rather, the first user can dynamically update the vCards without having to send new vCards.

In FIG. 9, the first and second user have a contract to share the information specified in the vCard and to share the skin applied to the vCard. More particularly, the first and second users each have a digital identity and identity accounts maintained on identity servers. The identity servers operate to keep track of the data items that the first and second users have contractually agreed to share. One of those data items is the skin to be applied to the first user's vCard.

As the first user changes a data item in the vCard, the identity server automatically transmits that data item to the second user as called for in the contract between those users. Likewise, if the first user changes the skin on the vCard shared with the second user, the identity server pushes the new skin out to the second user's identity server. The identity server then either applies the new skin to the vCard, or passes the new skin to a client holding the vCard. The new skin is then automatically applied to the vCard. In the case of a business vCard, the company logo for the first user's new employer is transmitted from the first user's identity server to the second user's identity server and the vCard is automatically updated to present the new logo.

In addition to or instead of the identity server automatically pushing the data item changed by the first user to the second user, the identity server may transmit an indication of the data item changed by the first user. By notifying the second user of the first user's changes, the second user may, for example, be able to accept or reject the first user's changes.

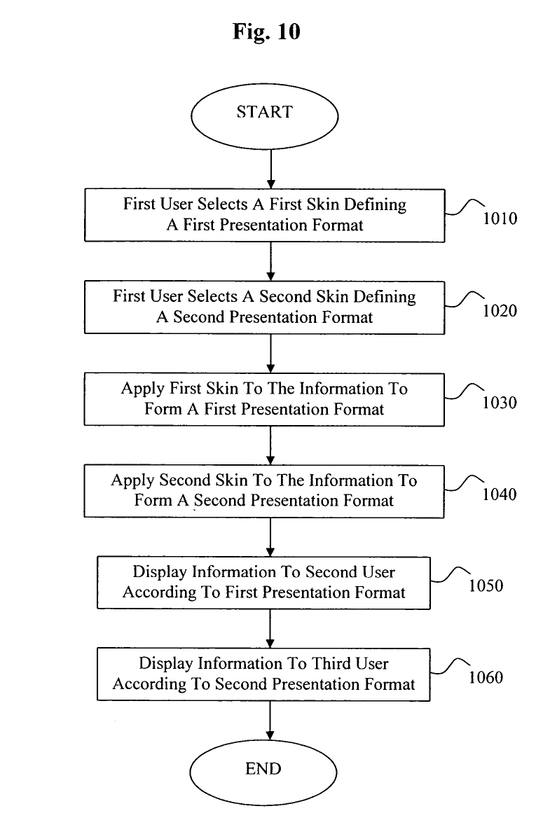

FIG. 10 is a flowchart for explaining another method of displaying information. In the method, a first user selects a first skin defining a first presentation format for information and a second skin defining a second presentation format for the information (1010, 1020). Preferably, but not necessarily, the information relates to the first user.

Then, the selected first skin is applied to the information to form a first presentation format of the information (1030). In a similar fashion, the selected second skin is applied to the information to form a second presentation format of the information (1040).

Thereafter, the information is displayed to a second user (e.g., at the second user's request) according to the first presentation format (1050). In a similar fashion, the information is displayed to a third user (e.g., at the third user's request) according to the second presentation format (1060). In this manner, the first user can control the manner in which the information is displayed to a plurality of other users, for example, the second and third users.

Additionally, once the selected first skin and/or the selected second skin is applied to the information, the information itself (e.g., a copy/instance thereof) may be altered according to the respective resulting presentations formats. The altered information, which corresponds to the application of the first or second skin, may then be stored so that it can be retrieved at a later time for displaying according to the presentation format.

Alternatively, the information can be transformed dynamically, for example, when a user requests the information to be displayed, so that the information is stored in a single form but is presented in different formats according to different skins applied “on the fly”.

Preferably, but not necessarily, the first user selects the first skin based on a relationship between the first user and the second user. Preferably, but not necessarily, the first user selects the second skin based on a relationship between the first user and the third user.

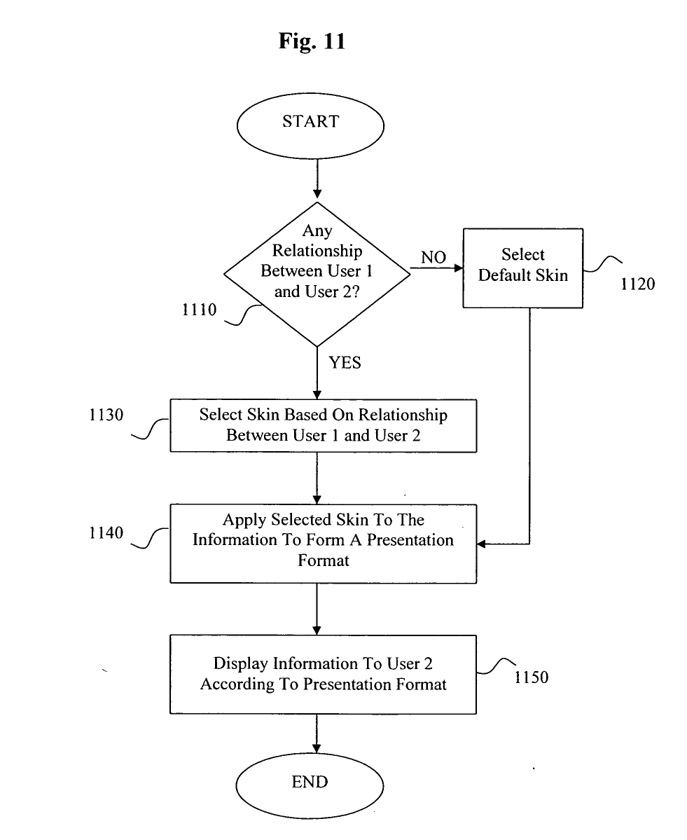

FIG. 11 is a flowchart for explaining a method of displaying information, according to yet another illustrative embodiment. In the method, it is determined whether or not a relationship exists (i.e., is defined) between a first user, User 1, and a second user, User 2 (1110).

If no relationship is defined between User 1 and User 2, a default skin is selected (1120). Otherwise, if a relationship is defined between User 1 and User 2, a skin is selected based on the relationship (1130).

Then, the selected relationship is applied to the information to form a presentation format ( 1140). As noted above, by applying the skin, the presentation format that is created may include adding information to the information that would normally be displayed, removing information from the information that would normally be displayed and/or altering the information (i.e., the actual content and/or its arrangement) that would normally be displayed.

Herein, the phrase “normally be displayed” refers to displaying the information without any skin being applied thereto. The default skin may correspond to no skin being applied.

The information is displayed (e.g., based on a request from User 2) to User 2 according to the presentation format (1150). Preferably, but not necessarily, the information relates to User 1.

In this manner, skins are selected and applied to the information (e.g., defining a vCard of a first user) for presenting the information in different formats to other users based on the relationships between the first user and the other users.

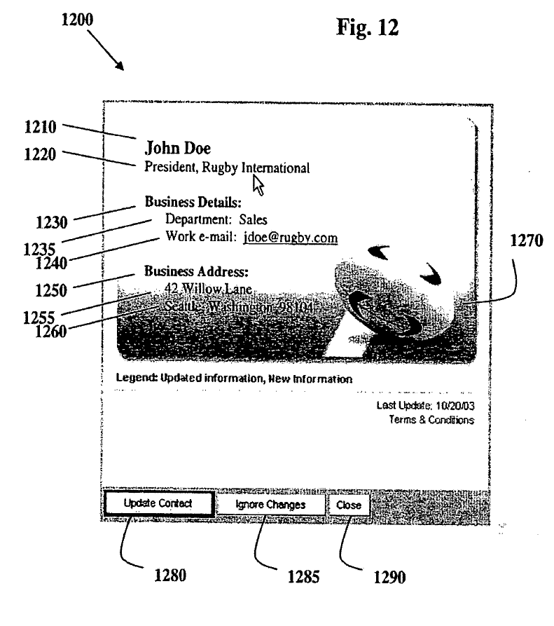

FIG. 12 shows an implementation of a vCard 1200 belonging to a user (i.e., the “owner” of the vCard) and having a skin applied thereto. Here, the owner is a member of a rugby club and has chosen a skin with a rugby theme to use with other members of his rugby club. The vCard 1200 includes data on the user including the user's name 1210, title and company 1220, department 1235, business e-mail address 1240 and business address 1255, 1260. The vCard 1200 also includes labels 1230, 1250 for presenting, organizing, etc. the user's information.

When the owner adds to or updates his or her contact information, which is presented in vCard 1200, another user having previously received the vCard 1200 may be notified of the new and/or updated information. For example, new information may be presented in a first color, updated information may be presented in a second color and unchanged information may be presented in a third (e.g., default) color.

Thereafter, through the use of command buttons 1280, 1285 and 1290, the user having previously received the vCard may elect to update the contact information via button 1280, ignore the changes to the contact information via button 1285 or simply end the presentation of the contact information by closing the vCard via button 1290.

The various illustrative embodiments described herein involve applying a skin to a vCard. These embodiments are merely illustrative and are not intended to be limiting in any manner. Indeed, these embodiments are provided merely to facilitate the description of the present invention, the scope of which is defined by the appended claims. For example, the dynamic skins described here can be used with the electronic notes described in the U.S. provisional patent application entitled Method of Updating Information in Electronic Notes, attorney docket number P8744, U.S. Application No. ______, filed Jun. 23, 2004, the disclosure of which is incorporated herein, in its entirety, by reference.

Thus, having described embodiments of the invention as set forth above, it is believed that other modifications, variations and changes will be suggested to those skilled in the art in view of the teachings set forth herein. It is therefore to be understood that all such variations, modifications and changes are believed to fall within the scope of the present invention as defined by the appended claims. Although specific terms are employed herein, they are used in their ordinary and accustomed manner only, unless expressly defined differently herein, and not for purposes of limitation.

1. A method of displaying information based on a relationship between a first user and a second user, the information including one or more data items that the first user and the second user have agreed to share under conditions specified in a contract, comprising:
receiving the information and presentation data indicating a first skin selected by the first user based on the relationship between the first and second users;
applying the first skin to the information to form a first presentation format of the information; and
displaying the information according to the first presentation format.

2. The method of claim 1, wherein the presentation data is the first skin.

3. The method of claim 1, further comprising if the first user changes one of the one or more data items, displaying for the second user the information including the changed data item according to the first presentation format.

4. The method of claim 1, wherein the relationship is based on a social relationship between the first user and the second user.

5. The method of claim 4, wherein the relationship is defined according to a digital identity of the first user and a digital identity of the second user.

6. The method of claim 1, wherein the information includes contact information for the first user.

7. The method of claim 6, wherein the contact information includes one or more of a name, a home telephone number, a work telephone number, a cellular phone number, a facsimile number, a job title, an employer, a home address and a work address of the first user.

8. The method of claim 1, wherein the information includes relationship information indicating the relationship between the first user and the second user.

9. The method of claim 8, wherein the relationship information indicates one of a business relationship and a personal relationship.

10. The method of claim 1, wherein applying the first skin includes adding an audio clip to the first presentation format.

11. The method of claim 12, wherein the first user specifies the audio clip to be added.

12. The method of claim 1, wherein applying the first skin includes adding a video clip to the first presentation format.

13. The method of claim 12, wherein the first user specifies the video clip to be added.

14. The method of claim 1, wherein applying the first skin includes adding an animation to the first presentation format.

15. The method of claim 14, wherein the first user specifies the animation to be added.

16. The method of claim 1, wherein applying the first skin includes adding an image to the first presentation format.

17. The method of claim 16, wherein the first user specifies the image to be added.

18. The method of claim 1, wherein applying the first skin includes adding a URL to the first presentation format.

19. The method of claim 18, wherein the first user specifies the URL to be added.

20. The method of claim 1, wherein the information is displayed as a vCard.

21. A method of sending information based on a relationship between a first user and a second user, the information including one or more data items that the first user and the second user have agreed to share under conditions specified in a contract, comprising:
selecting a first skin based on the relationship between the first user and the second user;
applying the first skin to the information to form a first presentation format of the information; and
sending the information to the second user according to the first presentation format.

22. The method of claim 21, wherein the information is sent over a network.

23. The method of claim 21, further comprising if the first user changes one of the one or more data items, automatically sending the updated information to the second user according to the first presentation format.

24. The method of claim 21, further comprising if the first user selects a second skin based on the relationship between the first user and the second user, automatically applying the second skin to the information to form a second presentation format of the information and sending the information to the second user according to the second presentation format.

25. The method of claim 21, wherein the relationship is defined by associating a digital identity of the first user and a digital identity of the second user.

26. The method of claim 21, wherein the relationship is based on a social relationship between the first user and the second user.

27. The method of claim 21, wherein the information includes contact information for the first user.

28. The method of claim 27, wherein the contact information includes one or more of a name, a home telephone number, a work telephone number, a cellular phone number, a facsimile number, a job title, an employer, a home address and a work address of the first user.

29. The method of claim 21, wherein the information includes relationship information indicating the relationship between the first user and the second user.

30. The method of claim 29, wherein the relationship information indicates one of a business relationship and a personal relationship.

31. The method of claim 21, wherein applying the first skin includes adding an audio clip to the first presentation format.

32. The method of claim 31, wherein the first user specifies the audio clip to be added.

33. The method of claim 21, wherein applying the first skin includes adding a video clip to the first presentation format.

34. The method of claim 33, wherein the first user specifies the video clip to be added.

35. The method of claim 21, wherein applying the first skin includes adding an animation to the first presentation format.

36. The method of claim 35, wherein the first user specifies the animation to be added.

37. The method of claim 21, wherein applying the first skin includes adding an image to the first presentation format.

38. The method of claim 37, wherein the first user specifies the image to be added.

39. The method of claim 21, wherein applying the first skin includes adding a URL to the first presentation format.

40. The method of claim 39, wherein the first user specifies the URL to be added.

41. A method of sending information based on a relationship between a first user and a second user, the information including one or more data items that the first user and the second user have agreed to share under conditions specified in a contract, comprising:
selecting a first skin based on the relationship between the first user and the second user;
sending the information and presentation data indicating the first skin to the second user.

42. The method of claim 41, wherein a default skin is automatically selected as the first skin if it is determined that no relationship exists between the first user and the second user.

43. The method of claim 41, wherein the information and the presentation data are sent over a network.

44. The method of claim 41, wherein the presentation data is the first skin.

45. A method of displaying information based on a first relationship between a first user and a second user and a second relationship between the first user and a third user, comprising:
the first user selecting a first skin, based on the first relationship, to be applied to the information to form a first presentation format of the information;
the first user selecting a second skin, based on the second relationship, to be applied to the information to form a second presentation format of the information;
sending the information and the first skin to the second user for displaying the information according to the first presentation format; and
sending the information and the second skin to the third user for displaying the information according to the second presentation format.

46. The method of claim 45, wherein the information includes one or more first data items that the first user and the second user have agreed to share under conditions specified in a first contract, and
wherein the information includes one or more second data items that the first user and the third user have agreed to share under conditions specified in a second contract.

47. The method of claim 46 wherein the first data items and the second data items are the same.

48. The method of claim 46, further comprising if at least one of the one or more first data items changes, automatically sending at least the changed first data items to the second user based on the first contract between the first user and the second user.

49. The method of claim 46, further comprising if at least one of the one or more second data items changes, automatically sending at least the changed second data items to the third user based on the second contract between the first user and the third user.

50. The method of claim 46, further comprising if at least one of the one or more first data items changes, automatically sending an indication of the changed first data items to the second user.

51. The method of claim 46, further comprising if at least one of the one or more second data items changes, automatically sending an indication of the changed second data items to the third user.

52. The method of claim 46, further comprising if after sending the information and the first skin to the second user, the first user selects a third skin, based on the first relationship, to be applied to the information to form a third presentation format of the information, automatically sending the information and the third skin to the second user for displaying the information according to the third presentation format.

53. The method of claim 46, further comprising if after sending the information and the second skin to the third user, the first user selects a third skin, based on the second relationship, to be applied to the information to form a third presentation format of the information, automatically sending the information and the third skin to the third user for displaying the information according to the third presentation format.
